(19) United States
(12) Patent Application Publication
(10) Pub. No.: US 2013/0057715 A1
(43) Pub. Date: Mar. 7, 2013

(54) ELECTRONIC DEVICE AND ANTI-SHAKE MODULE

(71) Applicant: Yi-Yuan Tsai, Changhua County (TW)

(72) Inventor: Yi-Yuan Tsai, Changhua County (TW)

(73) Assignee: ALTEK CORPORATION, Hsinchu City (TW)

(21) Appl. No.: 13/288,978

(22) Filed: Nov. 4, 2011

(30) Foreign Application Priority Data
Sep. 7, 2011 (TW) 100132278

(51) Int. Cl. H04N 5/228

(52) U.S. Cl. 348/208.99; 348/E05.031

(57) ABSTRACT

An electronic device including a main board, an anti-shake module and a lens module is provided. The lens module is disposed at a first surface or a second surface opposing the first surface of the main board. The anti-shake module includes a flexible printed circuit board (FPCB), an image sensor, a carrier, a first and second guide rod, a first and second moving plate. The image sensor is fixed to the second moving plate and electrically connected with the FPCB. The first and second moving plates are movably disposed at the first and second guide rods respectively. Herein the first moving plate is adapted to move along the axis of first guide rod. The second moving plate is adapted to move together with the first moving plate. And the second moving plate is adapted to move along the axis of second guide rod.

### CROSS-REFERENCE TO RELATED APPLICATION

This application claims the priority benefit of Taiwan application serial no. 100132278, filed on Sep. 7, 2011. The entirety of the above-mentioned patent application is hereby incorporated by reference herein and made a part of this specification.

### BACKGROUND OF THE INVENTION

1. Field of the Invention

The present invention relates to an electronic device. More particularly, the present invention relates to an electronic device having an anti-shake module.

2. Description of Related Art

With continuous improvement of image-sensing devices, micro-storage medium, and the reduced production cost, a digital camera market continues to expand, leading to a greater demand for more expensive cameras. However, a user did not hold the camera steady when taking a picture, the image captured by the camera will be fuzzy due to the shake. In particular, when a high magnification telescopic lens is used for capturing an image, minor vibration can cause significant fuzziness in the final picture. Hence, a means of minimizing the shaking of cameras for producing a clearer image is always a major research topic for camera manufacturers.

In general, the anti-shake structure is embedded into the lens module of a conventional camera having anti-shake function, and the image sensor, for example the charge coupled device image sensor (CCD image sensor), is coupled to the flexible printed circuit board (FPCB) is fastened to the main board. If the user needs the anti-shake function when using the camera, it is required to replace the lens with a lens having an anti-shake function and fasten the lens having an anti-shake function to the main board. However, not the cost of the lens having anti-shake function is expensive, but the manufacturing process is also complicated and the manufacturing cost of the camera is increased. Thus, since the camera capable of replacing lens module is already quite expensive, the requirement of replacing the lens module with a lens module having the anti-shake function may lead to inconvenience to the user and the price is also expensive for the user. Therefore, how to design and install an anti-shake structure into a normal and cost-effective camera (e.g., camera incapable of lens module replacing) is also an issue for the camera manufacturers to resolve.

### SUMMARY OF THE INVENTION

The present invention provides an electronic device with advantages of having an anti-shake function, a simplified structure and low cost.

The present invention provides an anti-shake module with advantages of a simplified structure and low cost and adapted to an electronic device needing anti-shake function.

The present invention provides an electronic device including a main board, an anti-shake module and a lens module. The main board has a first surface and a second surface opposing to the first surface. The anti-shake module is disposed on the first surface and includes a flexible printed circuit board, an image sensor, a carrying plate, at least one first guide rod, a first moving plate, at least one second rod and a second moving plate. The flexible printed circuit board is disposed on the first surface. The image sensor is electrically connected to the flexible printed circuit board. The carrying plate having a first opening is disposed on the first surface and the first opening exposes the image sensor. The first guide rod is fixed to a side wall of the first opening. The first moving plate having a second opening is located at the first opening and slidably disposed at the first guide rod. The second opening exposes the image sensor. Herein the first moving plate is adapted to move along the axis of the at least one first guide rod. The second guide rod is fixed to a side of the second opening and perpendicular to the first guide rod. The second moving plate having a third opening is located at the second opening and slidably disposed at the second guide rod. The image sensor is fixed to the second moving plate and located in the third opening. Herein the second moving plate is adapted to move together with the first moving plate, and the second moving plate is adapted to move along the axis of the second guide rode. The lens module is disposed on the first surface or the second surface of the main board.

The present invention further provides an anti-shake module disposed in the electronic device. The electronic device includes a main board and a lens module. The main board has a first surface and a second surface opposing to the first surface. The lens module is disposed on the first surface or the second surface of the main board. The anti-shake module is disposed on the first surface. The anti-shake module includes a flexible printed circuit board, an image sensor, a carrying plate, at least one first guide rod, a first moving plate, at least one second rod and a second moving plate. The flexible printed circuit board is disposed on the first surface. The image sensor is electrically connected to the flexible printed circuit board. The carrying plate having a first opening is disposed on the first surface and the first opening exposes the image sensor. The first guide rod is fixed to a side wall of the first opening. The first moving plate having a second opening is located at the first opening and slidably disposed at the first guide rod. The second opening exposes the image sensor. Herein the first moving plate is adapted to move along the axis of the at least one first guide rod. The second guide rod is fixed to a side of the second opening and perpendicular to the first guide rod. The second moving plate having a third opening is located at the second opening and slidably disposed at the second guide rod. The image sensor is fixed to the second moving plate and located in the third opening. Herein the second moving plate is adapted to move together with the first moving plate, and the second moving plate is adapted to move along the axis of the second guide rode.

According to an embodiment of the present invention, a number of the at least one first guide rod is two and the first guide rods are parallel to each other.

According to an embodiment of the present invention, a number of the at least one second guide rod is two and the second guide rods are parallel to each other.

According to an embodiment of the present invention, when the lens module is disposed on the first surface, the anti-shake module is located between the main board and the lens module.

According to an embodiment of the present invention, the anti-shake module further includes a driving device adapted to drive the first moving plate and the second moving plate.

In light of the above, the user can use the anti-shake function of the electronic device of the present invention without the requirement of the replacing of lens module because of the anti-shake module disposed on the main board. Furthermore, compared to the conventional cameras with the anti-shake function integrated to the lens module, the manufacturing cost of the electronic device of the present invention is effectively reduced since the anti-shake function is disposed on the main board. In addition, the user can also use the anti-shake function of the electronic device without the requirement of replacing the lens module.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view of an electronic device according to an embodiment of the present invention.

FIG. 2 is a top view showing parts of the electronic device in FIG. 1.

FIG. 3 is an explosive view of the anti-shake module of the electronic device of FIG. 1.

FIG. 4 illustrates the lens module and the anti-shake module disposed on the same surface of the main board of the electronic device of FIG. 1.

FIG. 5 illustrates the lens module and the anti-shake module disposed on the different surfaces of the main board of the electronic device of FIG. 1.

### DESCRIPTION OF EMBODIMENTS

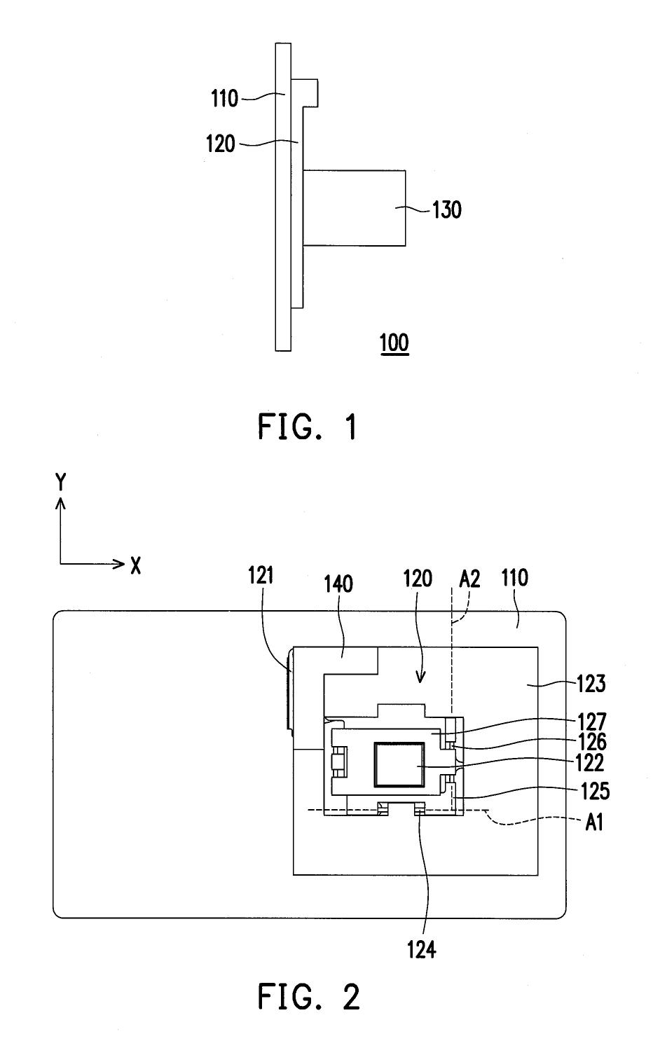

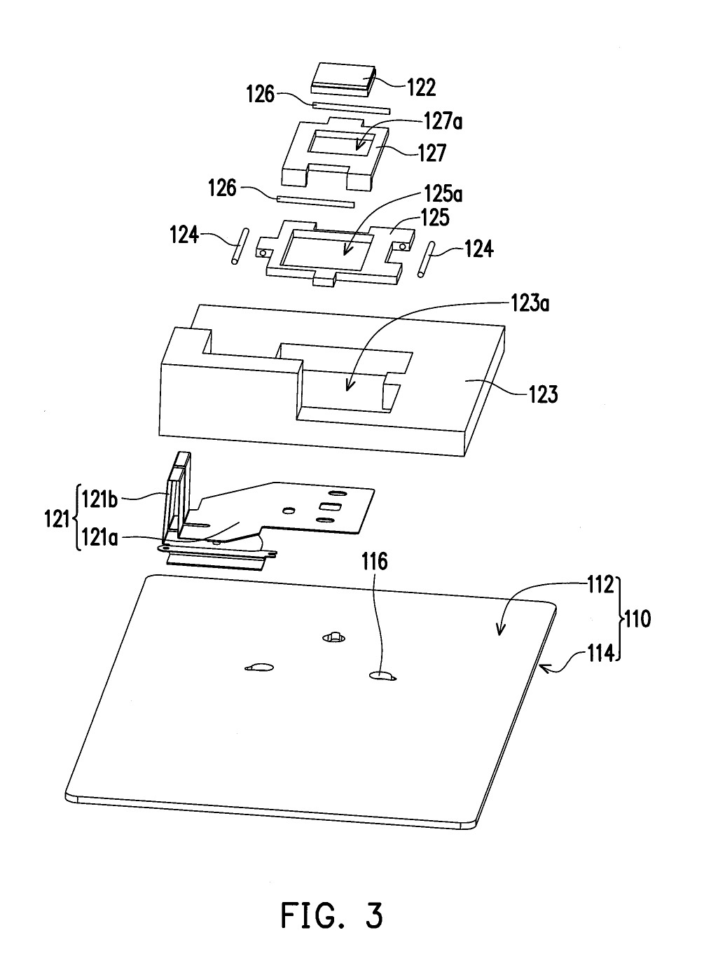

FIG. 1 is a schematic view of an electronic device according to an embodiment of the present invention. Referring to FIG. 1, the electronic device 100 of the present invention is a camera, for example, and includes a main board 110, an anti-shake module 120 and a lens module 130. FIG. 2 is a top view showing parts of the electronic device in FIG. 1. FIG. 3 is an explosive view of the anti-shake module of the electronic device of FIG. 1. Referring to FIG. 2 and FIG. 3 together, the main board 110 of the electronic device 100 has a first surface 112 and a second surface 114 opposing to the first surface 112. The anti-shake module 120 is disposed on the first surface 112 and includes a flexible printed circuit board 121, an image sensor 122, a carrying plate 123, at least one first guide rod 124, a first moving plate 125, at least one second rod 126 and a second moving plate 127.

In the present embodiment, the flexible printed circuit board 121 is disposed on the first surface 112 of the main board 110. The flexible printed circuit board 121 has a board portion 121a and a bending portion 121b. The board portion 121a and the bending portion 121b are connected to each other. The bending portion 121b is flexible so as to provide a dumping effect to the disposed components. The image sensor 122 is electrically connected to the flexible printed circuit board 121. The carrying plate 123 having a first opening 123a is disposed on the first surface 112 and the first opening 123a exposes the image sensor 122. In the embodiment, the image sensor 122 may be a charge coupled device (CCD) image sensor or a complementary metal oxide semiconductor (CMOS) sensor. The carrying plate 123 is fastened to the main board 110 by means of screwing. For example, a plurality of holes 116 are disposed on the main board 110 so that the carrying plate 123 is screwed up to the main board 110 through the holes 116.

The first guide rod 124 is fixed to a side wall of the first opening 123a. The first moving plate 125 having a second opening 125a is located at the first opening 123a and slidably disposed at the first guide rod 124. The second opening 125a exposes the image sensor 122. In the embodiment, the number of the first guide rods 124 is two as an example. Thus, the two first guide rods 124 are located at the opposing side walls of the first opening 123a respectively. And the two first guide rods 124 are parallel to each other. In addition, the first moving plate 125 is slidably disposed at the two first guide rods 124 with the two first guide rods 124 passing through the two sides of the first moving plate 125. Thus, the two first guide rods 124 are disposed as simultaneously passing through the two side walls of the carrying plate 123 and the two sides of the first moving plate 125 respectively. In addition, the electronic device 100 of the embodiment further includes a driving device (not shown) adapted to drive the first moving plate 125 and the second moving plate 127. Herein the driving device drives the first moving plate 125 so that the first moving plate 125 can move along the axis A1 of the first guide rod 124, as shown as the X direction in FIG. 2.

The second guide rod 126 is fixed to a side of the second opening 125a and perpendicular to the first guide rod 124. The second moving plate 127 having a third opening 127a is located at the second opening 125a and slidably disposed at the second guide rod 126. The image sensor 122 is fixed to the second moving plate 127 and located in the third opening 127a. In the embodiment, similar to the first guide rods 124, the number of the second guide rods 126 is two as an example. Thus, the two second guide rods 126 are located at the opposing side walls of the second opening 125a respectively. And the two second guide rods 126 are parallel to each other. In addition, the second moving plate 127 is slidably disposed at the two second guide rods 126 with the two second guide rods 126 passing through the two sides of the second moving plate 127. Thus, the two second guide rods 126 are disposed as simultaneously passing through the two side walls of the first moving plate 125 and the two sides of the second moving plate 127 respectively. Herein the second moving plate 127 moves along with the first moving plate 125. In other words, the first moving plate 125 drives the second moving plate 127 to move along the axis A1 of the first guide rod 124. And the driving device drives the second moving plate 127 so that the second moving plate 127 can move along the axis A2 of the second guide rod 126, as shown as the Y direction in FIG. 2.

It has to be noted that, since the image sensor 122 is disposed at the second moving plate 127, when the driving device drives the first moving plate 125, the first moving plate 125 drives the second moving plate 127 to move along the axis A1 of the first guide rod 124. At this moment, the image sensor 122 is driven to move along the X direction in FIG. 2. And when the driving device drives the second moving plate 127, the second moving plate 127 moves along the axis A2 of the second guide rod 126, the image sensor 122 is also driven to move along the Y direction in FIG. 2. In this way, the image sensor 122 can move in the directions of the axis A1 of the first guide rod 124 and the axis A2 of the second guide rod 126 which is perpendicular to the first guide rod 124, so as to achieve the anti-shake function of the electronic device 100.

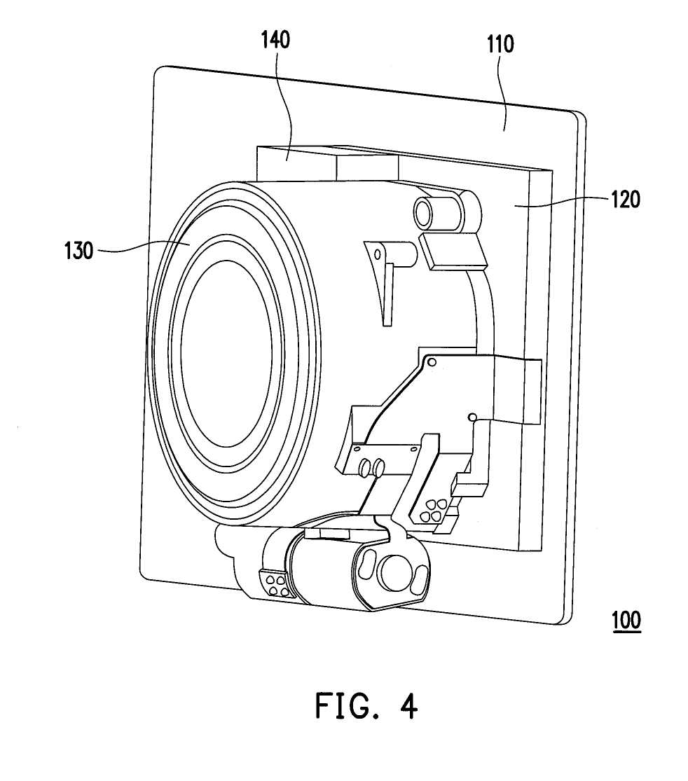

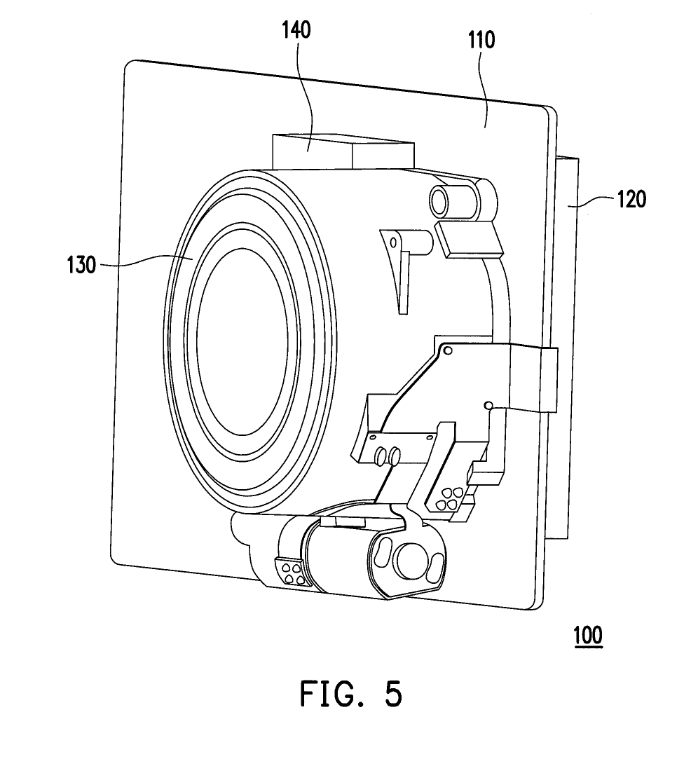

FIG. 4 illustrates the lens module and the anti-shake module disposed on the same surface of the main board of the electronic device of FIG. 1. FIG. 5 illustrates the lens module and the anti-shake module disposed on the different surfaces of the main board of the electronic device of FIG. 1. Referring to FIG. 4 and FIG. 5 together, the lens module 130 is disposed on the first surface 112 or the second surface 114 of the main board 110. As shown in FIG. 4, when the lens module 130 is disposed on the first surface 112 of the main board 110, the anti-shake module 120 is located between the main board 110 and the lens module 130. As shown in FIG. 5, when the lens module 130 is disposed on the second surface 114 of the main board 110, the main board 110 is located between the anti-shake module 120 and the lens module 130. Herein the disposing of the image sensor 122 and the flexible printed circuit board 121 has to be adjusted according to the disposing direction of the lens module 130, so that the image sensor 122 can receive the light after the light passes through the lens module 130.

Additionally, the electronic device 100 of the embodiment further includes a stopping block 140 disposed on the first surface 112 or the second surface 114 of the main board 110, and adapted to position the location of the lens module 130 disposing to the main board 110. In other words, in order to facilitate the positioning and assembling of the lens module 130, the disposing of the stopping block 140 can change according to the configuration of the lens module 130.

In light of the foregoing, the user can use the anti-shake function of the electronic device of the present invention without the requirement of the replacing of lens module because of the anti-shake module disposed on the main board. Furthermore, compared to the conventional cameras with the anti-shake function integrated to the lens module, the manufacturing cost of the electronic device of the present invention is effectively reduced since the anti-shake function is disposed on the main board. In addition, the user can also use the anti-shake function of the electronic device without the requirement of replacing the lens module. Thus, the anti-shake module is adapted to dispose in electronic devices, for example cameras, so that the user can choose the electronic device having both anti-shake function and low price.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An electronic device, comprising:
a main board having a first surface and a second surface opposing to the first surface;
an anti-shake module disposed on the first surface, comprising:
a flexible printed circuit board disposed on the first surface;
an image sensor electrically connected to the flexible printed circuit board;
a carrying plate having a first opening and disposed on the first surface and the first opening exposing the image sensor;
at least one first guide rod fixed to a side wall of the first opening;
a first moving plate having a second opening, located at the first opening and slidably disposed at the at least one first guide rod, the second opening exposing the image sensor, wherein the first moving plate is adapted to move along the axis of the at least one first guide rod;
at least one second guide rod fixed to a side of the second opening and perpendicular to the at least one first guide rod;
a second moving plate having a third opening, located at the second opening and slidably disposed at the at least one second guide rod, the image sensor being fixed to the second moving plate and located in the third opening, wherein the second moving plate is adapted to move together with the first moving plate, and the second moving plate is adapted to move along the axis of the at least one second guide rod; and
a lens module disposed on the first surface or the second surface of the main board.

2. The electronic device as claimed in claim 1, wherein the number of the at least one first guide rod is two and the first guide rods are parallel to each other.

3. The electronic device as claimed in claim 1, wherein the number of the at least one second guide rod is two and the second guide rods are parallel to each other.

4. The electronic device as claimed in claim 1, wherein when the lens module is disposed on the first surface, the anti-shake module is located between the main board and the lens module.

5. The electronic device as claimed in claim 1, further comprising a stopping block disposed on the first surface or the second surface of the main board, and adapted to position the location of the lens module disposing to the main board.

6. The electronic device according to claim 1, further comprising a driving device adapted to drive the first moving plate and the second moving plate.

7. An anti-shake module disposed in an electronic device, the electronic device comprising a main board and a lens module, the main board having a first surface and a second surface opposing to the first surface, the lens module disposed on the first surface or the second surface, the anti-shake module disposed on the first surface, and the anti-shake module comprising:
a flexible printed circuit board disposed on the first surface;
an image sensor electrically connected to the flexible printed circuit board;
a carrying plate having a first opening and disposed on the first surface and the first opening exposing the image sensor;
at least one first guide rod fixed to a side wall of the first opening;
a first moving plate having a second opening, located at the first opening and slidably disposed at the at least one first guide rod, the second opening exposing the image sensor, wherein the first moving plate is adapted to move along the axis of the at least one first guide rod;
at least one second guide rod fixed to a side of the second opening and perpendicular to the at least one first guide rod; and
a second moving plate having a third opening, located at the second opening and slidably disposed at the at least one second guide rod, the image sensor being fixed to the second moving plate and located in the third opening, wherein the second moving plate is adapted to move together with the first moving plate, and the second moving plate is adapted to move along the axis of the at least one second guide rod.

8. The anti-shake module as claimed in claim 7, wherein the number of the at least one first guide rod is two and the first guide rods are parallel to each other.

9. The anti-shake module as claimed in claim 7, wherein the number of the at least one second guide rod is two and the second guide rods are parallel to each other.

10. The anti-shake module as claimed in claim 7, wherein when the lens module is disposed on the first surface, the anti-shake module is located between the main board and the lens module.

11. The anti-shake module according to claim 7, further comprising a driving device adapted to drive the first moving plate and the second moving plate.
